(19) United States
(12) Patent Application Publication
(10) Pub. No.: US 2005/0183066 A1
(43) Pub. Date: Aug. 18, 2005

(54) Correlating debugger

(76) Inventor: Monji G. Jabori, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/780,157

(22) Filed: Feb. 17, 2004

(51) Int. Cl. G06F 9/44

(52) U.S. Cl. 717/124

(57) ABSTRACT

Systems, methodologies, media, and other embodiments associated with a correlating debugger are described. One exemplary system embodiment includes logics for receiving data from a hardware analyzer and a software analyzer, for establishing a relationship between the hardware analyzer and the software analyzer, and for creating a time-ordered set of data from data received from the hardware analyzer and the software analyzer.

### BACKGROUND

Software debuggers are useful to debug (e.g., analyze, trouble-shoot) software. Hardware analyzers are useful to debug hardware. But some computer problems (“bugs”) are neither pure software nor pure hardware problems, arising due to interactions between hardware and software. For example, a device (hardware) may generate signals (e.g., interrupts) that are handled by a device driver (software). The device driver may interact with other software like an operating system, which may in turn, interact with other devices and other software (e.g., applications). The device and the device driver may perform as desired under a first set of conditions (e.g., hardware and software configuration) but may not perform as desired under a second set of conditions. The engineer trying to diagnose and hopefully correct the problem may employ a software debugger and/or a hardware debugger.

The software debugger may produce a set of data that when analyzed reveals no problem with the software. Similarly, the hardware debugger may produce a set of data that when analyzed reveals no problem with the hardware. Yet the engineer confronted with trouble-shooting the problem knows there is a problem and may be at a loss to discover what interaction(s) between the device (hardware) and device driver (software) produced the problem. The increasing prevalence of external, detachably operably connectable devices (e.g., Universal Serial Bus (USB) devices), and the increasing complexity of operating systems may lead to more of these types of interaction errors which tend to be intermittent, apparently random in time of occurrence, and difficult to recreate. Furthermore, isolating the device and/or the device driver may remove the condition(s) that produced the interaction error.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example correlating debugger.

FIG. 2 illustrates another example correlating debugger.

FIG. 3 illustrates an example method for organizing data from a hardware analyzer and a software analyzer.

FIG. 4 illustrates another example method for organizing data from a hardware analyzer and a software analyzer.

FIG. 5 illustrates an example timing diagram illustrating data available in a time-ordered data set.

FIG. 6 illustrates an example computing environment in which example systems and methods illustrated herein may operate.

FIG. 7 illustrates an example image forming device in which example systems and methods illustrated herein may operate.

FIG. 8 illustrates an example application programming interface (API).

### DETAILED DESCRIPTION

Hardware analyzers facilitate analyzing hardware in operation. Hardware analyzers can produce and store data associated with an operating hardware device like timing data, state transition data, wave data and so on. Software analyzers facilitate analyzing software in operation. Software analyzers can produce and store data associated with an executing software component like register data, stack data, heap data, variable data, interrupt data, I/O request packet (IRP) data, device object, and so on. A correlating debugger facilitates correlating data from the hardware analyzer and/or information associated with the hardware being analyzed and data from the software analyzer and/or information associated with the software being analyzed. Correlating the data, (e.g., organizing the data according to mutual relationships like hardware device, hardware device operation, time) facilitates providing a useful, complete, coordinated picture of an interaction between the analyzed hardware device and the analyzed software. Thus, in one example, a “correlating debugger” facilitates establishing relationships between debug data from different sources and producing time-ordered data that may facilitate debugging interaction problems.

An example correlating debugger may employ a binding data to facilitate organizing and/or ordering a set of data from a hardware analyzer with a set of data from a software analyzer. Additionally, and/or alternatively, the correlating debugger may use the binding data to relate a device being analyzed to a device driver and/or application being analyzed, which in turn facilitates organizing and/or ordering the data. The binding data may be, for example, a relation between hardware identifying data that facilitates uniquely identifying a hardware device for which the hardware analyzer is producing data and software identifying data that facilitates uniquely identifying software for which the software analyzer is producing data. In one example, the hardware identifier may be based on information available in and/or to an IRP data structure and/or a device object associated with a hardware device related to processing associated with the IRP. An IRP is a data structure that may be passed up and/or down a device driver stack to facilitate passing read, write, and/or control data within the device driver stack. The IRP can facilitate communicating information between an operating system and a device driver. An IRP may reference a device object that facilitates relating a hardware device to an operating system. Thus, the example hardware identifier that may be based on a hardware number related to an IRP data structure facilitates correlating a logical device and a physical device. For example, while a serial port device driver may be programmed to handle interrupts from either COM1 or COM2, an actual interrupt will be associated with a specific serial port, which may be indicated by the hardware number. Similarly, while a different driver and/or application may be configured to poll a hardware device to ascertain a state or condition, a hardware identifier can facilitate identifying which hardware device to poll. While a device object, a hardware identifier, and an IRP are described above, it is to be appreciated that the binding data and/or a relationship between a hardware device and software related to that hardware device may be established by other means, including manually. The manner in which the relationship between the hardware device and the software can be formed may vary depending, for example, on a bus type employed to facilitate communications between the software and the hardware device and/or a method by which data is communicated between the hardware device and the software.

The software debugger can be programmed to acquire data associated with a device driver that handles processing associated with the device identified by the hardware identifier. For example, a mouse device driver may process interrupts and/or system requests from a USB mouse, where the USB mouse is identifiable by the hardware identifier. Additionally, and/or alternatively, the device driver may poll the hardware to ascertain a state or condition. The hardware identifier can be used to program a hardware analyzer to acquire signals generated by the device associated with the hardware identifier. By way of illustration, the IRP hardware identifier may indicate that the hardware analyzer should acquire data associated with the USB mouse whose interrupts are being processed by or whose state is being ascertained by the device driver that is being analyzed by the software analyzer. By way of further illustration, the debugging engineer may program the correlating debugger and/or arrange various physical connections to establish a relationship between the hardware being analyzed and the software being analyzed. The binding data and/or relationship may also facilitate programming a trigger for a correlating debugger to start and/or stop storing data from a hardware analyzer and a software analyzer into a correlated data set. In one example, the trigger may be programmed to begin storing data into the correlated data set when the hardware device generates a certain type of signal (e.g., interrupt). In another example, the trigger may be programmed to begin storing data into the correlated data set when the software receives a certain type of request (e.g., enable USB mouse) or ascertains that a certain state exists.

Thus, the correlating debugger may facilitate mitigating issues associated with hardware engineers hooking up analyzers and/or scopes to acquire a snapshot of a device before it fails and software engineers separately engaging software debuggers to analyze what occurred in software before the system failed, which typically leads to the two engineers analyzing the interaction problem in isolation and not being able to correlate data. In one example, the correlating debugger may employ a marker that is employed by the software debugger as a time indicator that facilitates identifying when certain events reported by the hardware analyzer occurred. A trigger signal generated by a hardware analyzer may be trapped by a software debugger and serve as an interface to facilitate synchronizing and merging the hardware data and the software data.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

As used in this application, “software component” refers to a piece of software, as software is defined herein. A software component may be, for example, a program, an object, a subroutine, a function, a device driver, and so on.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

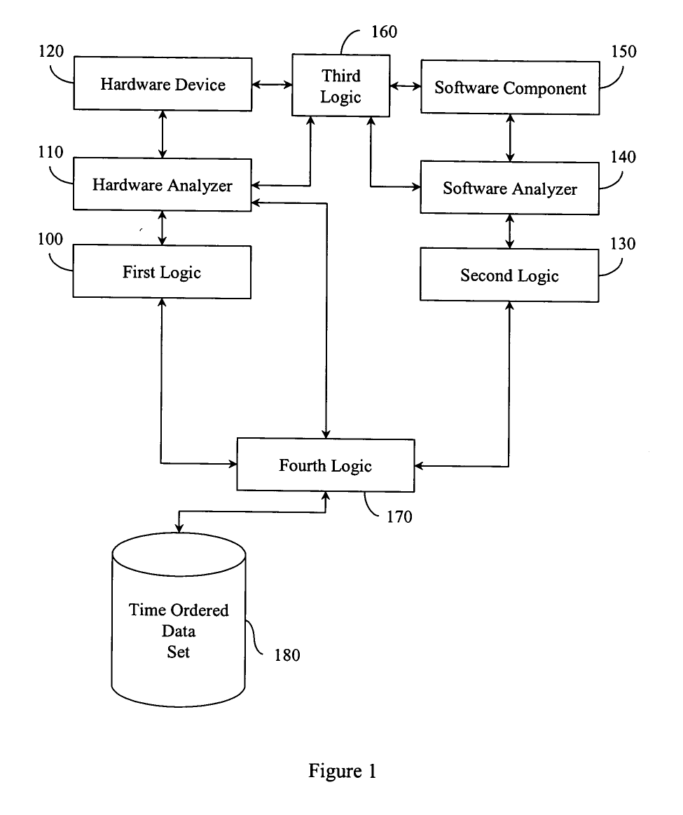

FIG. 1 illustrates an example correlating debugger. The correlating debugger may include a first logic 100 configured to receive a first data set from a hardware analyzer 110 that is configurable to analyze a hardware device 120. The hardware analyzer 110 may be, for example, a programmable oscilloscope, a protocol analyzer, and the like. The first data set may include, for example, timing information, state information, state change information, interrupt information, a register value, a memory location value, voltage information, and the like. The hardware device 120 may be, for example, a USB (Universal Serial Bus) device (e.g., USB 1.1, USB 2.0), a SCSI (Small Computer Systems Interface) device, an ISA (Industrial Standard Architecture) device, an EISA (Extended Industrial Standard Architecture) device, a PCI (Peripheral Component Interconnect) device, a PCI Express (PCIE) device, an MSA (Microchannel Architecture) device, a Serial Advanced Technology Attachment (SATA) device (e.g., hard disk drive, other storage device), an Infiniband device, an Ethernet device (e.g., 10/100/1000 Mb), a 1394 device (e.g., 1995a, 1995b, 1394b), a computer, a computer sub-system, a mouse, a disk, a monitor, a peripheral, and so on. The hardware analyzer 110 may be detachably, operably connected to the hardware device 120 and the first logic 100.

The correlating debugger may also include a second logic 130 configured to receive a second data set from a software analyzer 140 that is configurable to analyze a software component 150. The software analyzer 140 may be, for example, a debugger, a kernel debugger (e.g., kdb), and the like. The software component 150 may be, for example, a device driver, an application, an object, and so on. The second data set may include, for example, timing information, state information, state change information, interrupt information, a register value, a memory location value, a value for a data variable, and the like. The second data set may also include information about a function call, a subroutine call, a method call, a stack, a heap, a procedure call, and the like.

The correlating debugger may also include a third logic 160 configured to receive a binding data from the hardware analyzer 110 and/or the software analyzer 140. The binding data may facilitate synchronizing the first data set and the second data set. For example, the hardware analyzer 110 may produce, substantially continuously, a stream of data associated with the hardware device 120. Similarly, the software analyzer 140 may produce, substantially continuously, a stream of data related to the software component 150. But since it may be an interaction between the hardware device 120 and the software component 150 in which the trouble-shooter is interested, the binding data may facilitate identifying to the hardware analyzer 110 a specific hardware device 120 and a specific hardware operation performed by the hardware device 120 to monitor. Similarly, the binding data may facilitate identifying to the software analyzer 140 a specific software component 150 and a specific software operation performed by the software component 150 to monitor. Thus, the hardware analyzer 110 and the software analyzer 140 can be synchronized to collect data that is correlated on the mutual relationships of device, operation, time, and so on. In one example, the binding data is based on data available in or to an IRP data structure (e.g., hardware identifier). In another example, the binding data may be entered into the correlating debugger by a user. In still another example, the binding data may be determined by the correlating debugger after various physical connections (e.g., cabling, bus connections) are established.

The correlating debugger may also include a fourth logic 170 operably connected to the first logic 110 and the second logic 130. The fourth logic 170 may be configured to receive a signal that indicates that an interaction between the hardware device 120 and the software component 150 has occurred. The signal may be generated by the hardware analyzer 110. Thus, upon receiving the signal, the fourth logic 170 may begin selectively storing elements of the first data set and the second data set in a time-ordered data set 180. In one example, the signal is a non-maskable interrupt (NMI). In another example, the signal is an external trigger.

The time-ordered data set 180 may be stored, for example, in a data store. The time-ordered data set 180 may include elements of the first data set and elements of the second data set. The elements may be arranged together, in order, based on time. Thus, the trouble-shooter may have a comprehensive set of correlated data that is time-ordered that may facilitate trouble-shooting an interaction problem.

While FIG. 1 illustrates four logics as separate blocks, it is to be appreciated that two or more of the logics could be combined into a single logic. Furthermore, processing performed by a logic may be distributed between a greater number of logics. In one example, a first processor (e.g., microprocessor) may execute processor executable instructions of the software component 150 and a second processor may execute processor executable instructions associated with the first logic 100, the second logic 130, the third logic 160, and/or the fourth logic 170. In another example, a first processor may execute processor executable instructions of the software component 150 and processor executable instructions associated with one or more of, the first logic 100, the second logic 130, the third logic 160, and the fourth logic 170. Thus, it is to be appreciated that various configurations of embedded analyzers/debuggers and stand alone analyzers/debuggers may be employed.

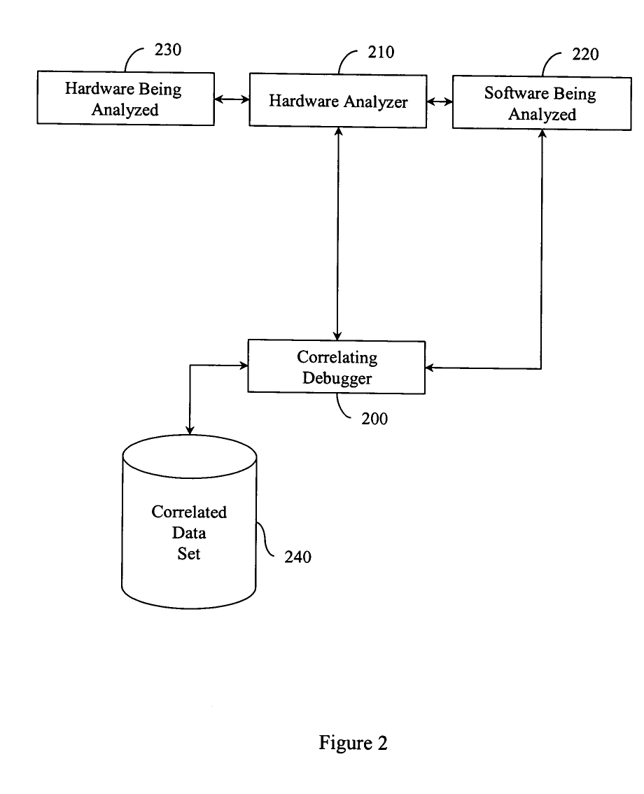

FIG. 2 illustrates another example correlating debugger 200. The correlating debugger 200 may be configured to receive data from a hardware analyzer 210 and from software 220 being analyzed. In one example, the software 220 being analyzed may run on the same processor as the correlating debugger 200. In another example, the software 220 being analyzed may run on a different processor, and be analyzed by a software analyzer (not illustrated) that sends data to the correlating debugger 200. In another example, the correlating debugger 200 may itself analyze the software 220 being analyzed.

In one example, the software 220 being analyzed (e.g., a device driver) may have access to a hardware identifier that facilitates identifying a piece of hardware with which the software 220 may interact. The hardware identifier can thus be used to program the hardware analyzer 210 to look for events, state information, data, and so on associated with that piece of hardware. In another example, a user may establish the relationship between the software 220 and the hardware analyzer 210 in the correlating debugger 200. When the hardware 230 being analyzed enters a state being looked for, or generates an interrupt being looked for, or so on, the hardware analyzer 210 may generate an NMI to the correlating debugger 200. Additionally, and/or alternatively, the hardware analyzer 210 may generate a signal, an external trigger, and the like. Thus, the correlating debugger 200 can create a correlated data set 240 that includes data associated with the hardware analyzer 210 and the software 220 being analyzed. The correlated data set 240 may be stored, for example, in a data store.

Thus, in one example, the correlating debugger 200, whether implemented as a program running on a processor, an ASIC (Application Specific Integrated Circuit), a distributed program, a hard-wired circuit, a stand alone electronic device, a logic, or so on, may provide means for receiving data from the hardware analyzer 210, means for receiving data from software analyzer (not illustrated, but in some examples the correlating debugger 200 itself), and means for coordinating the activity of the hardware analyzer 210 and the software analyzer so that data received from the hardware analyzer 210 and data received from the software analyzer can be merged in the correlated data set 240. Furthermore, the correlating debugger 210 may provide means for initiating writing data received from the hardware analyzer 210 and data received from the software analyzer to the correlated data set 240.

In one example, a software debugger may be configured to log USB activity related to a target device like a mouse. The software debugger may be located on a computer dedicated to debugging the target device or on a computer that is experiencing the problem that lead to engaging the correlating debugger. Employing a computer dedicated to debugging the target device may mitigate issues associated with timing problems (e.g., race conditions) created by inserting additional computer components into a platform being tested. A USB analyzer may be configured to monitor the device associated with the device identifier (e.g., hardware number) programmed into the software debugger. Upon the occurrence of an event (e.g., mouse click), the USB analyzer may generate an NMI to a host processor or other processor being employed to handle high priority interrupts for the correlating debugger 200.

The software debugger may be configured with an NMI interrupt handler and thus may store data identifying the point in time at which the NMI was received. The NMI may indicate that a certain stage in a hardware transaction occurred. Thus, stored data can include time stamps associated with various hardware events occurring. Therefore, it is to be appreciated that the correlated data set 240 may include data generated by the hardware analyzer 230, information relating to processing performed by the hardware analyzer 230, and/or information concerning a signal (e.g., NMI) produced by the hardware analyzer 210. Similarly, it is to be appreciated that the correlated data set 240 may include data generated by the software 220 being analyzed and/or the correlating debugger 200. After establishing the hardware device in which the correlating debugger 200 is interested, by, for example, using the hardware identifier, the correlating debugger 200 may store software data (e.g., register values, stack values, variable values), and markers from the hardware analyzer 210 indicating that various hardware events (e.g., state changes, edges encountered) occurred.

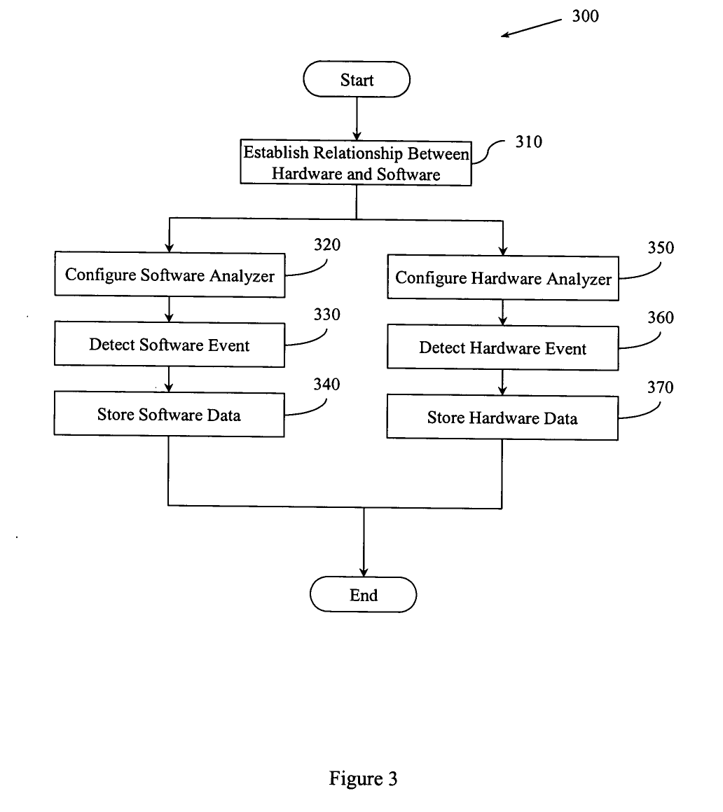

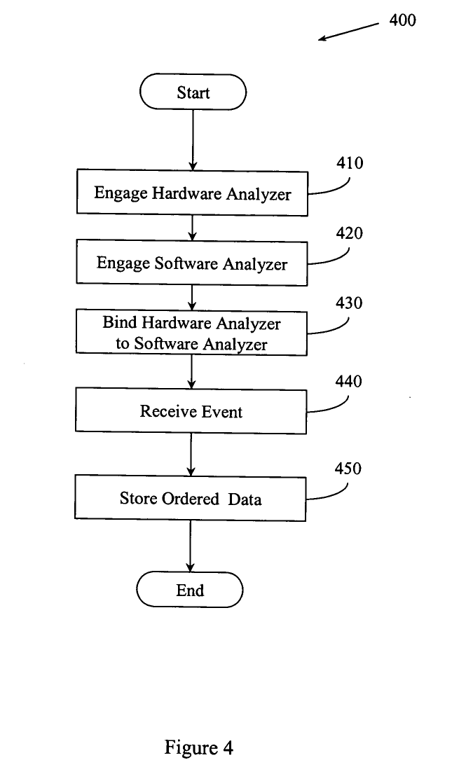

Example methods may be better appreciated with reference to the flow diagrams of FIGS. 3 and 4. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 3 illustrates an example method 300 for organizing data from a hardware analyzer and a software analyzer (e.g., debugger kdb). The method 300 may include, at 310, establishing a relationship between a hardware device and a software component that will perform a software operation related to the hardware device. The relationship may be established, for example, in a correlating debugger. In one example, the relationship may be established by a user configuring the correlating debugger. In another example, establishing the relationship may include identifying a hardware number known to the software component, communicating the hardware number to the correlating debugger and/or hardware analyzer, correlating the software component and a hardware device based on the hardware number and configuring the hardware analyzer to analyze the hardware device.

The method 300 may also include, at 320, configuring a software analyzer to collect a first data set related to the software component as the software component performs the software operation. Configuring the software analyzer at 320 may also include configuring the software analyzer to deliver the first data set to the correlating debugger. In one case, the software analyzer may be the correlating debugger, and thus delivering the data related to the software component may include writing data to a file, a record, a data store, and so on. In one example, configuring the software analyzer at 320 may include identifying various types of data available in the software component and establishing a frequency with which the data types will be sampled.

The method 300 may also include, at 350, configuring a hardware analyzer to collect a second data set related to the hardware device as the hardware device performs a hardware operation. Configuring the hardware analyzer at 350 may also include configuring the hardware analyzer to deliver the second data set to the correlating debugger. It is to be appreciated that while actions at 320 and 350 are illustrated occurring substantially in parallel, that the actions could occur serially. In one example, configuring the hardware analyzer may include identifying various types of data available in the hardware device, and identifying various types of events that may occur in the hardware device.

The method 300 may also include, at 330, detecting a first event that signals the beginning of a software operation in which a trouble-shooter is interested and controlling the software analyzer to begin delivering the first data set to the debugger. In one example, the software component may be a device driver and the first event may be an IRP arriving at a pre-determined, configurable level in the device driver.

The method 300 may also include, at 360, detecting a second event that signals the beginning of a hardware operation in which the trouble-shooter is interested and controlling the hardware analyzer to begin delivering the second data set to the debugger. The second event may be, for example, a state change or voltage change on the hardware device being analyzed. In another example, the second event may be a state change on an operable connection between the hardware device and the software component.

The method 300 may also include, at 340, selectively storing together, in order, elements of the first data set and the second data set, where the order is based, at least in part, on the time at which an event associated with generating a data element occurred. Selectively storing the data together can include, at 340, storing data related to the software and, at 370, storing data related to the hardware. In one example, selectively storing together elements of the first data set and the second data set may include selectively adding an element of the second data set to the first data set.

While FIG. 3 illustrates various actions occurring serially, it is to be appreciated that various actions illustrated in FIG. 3 could occur substantially in parallel. By way of illustration, a first process could configure the software and hardware analyzers. Similarly, a second process could detect the hardware and software events, while a third process could store the hardware data and the software data. While three processes are described, it is to be appreciated that a greater and/or lesser number of processes could be employed and that lightweight processes, regular processes, threads, and other approaches could be employed.

In one example, the method for organizing hardware analyzer data and software analyzer data can facilitate debugging devices like hardware busses that are evolving towards a serial transfer model. For example, PCI, which is a conventional 32 bit parallel bus, is transitioning to a 2.5 GHz serial bus referred to as PCI Express (PCIE). Similarly, USB 2.0, 1394b, Serial ATA, Infiniband and others are high speed serial buses that may be analyzed by a correlating debugger. These serial buses may employ a transactional model with packets of variable length and error checking. Thus, the methods for establishing a relationship between a hardware device connected to such a bus and the software being analyzed in connection with the hardware device operation may be achieved by various means that may not include referencing a hardware identifier available in a device object.

FIG. 4 illustrates another example method 400 for organizing data from a hardware analyzer and a software analyzer (e.g., debugger kdb). The method 400 may include, at 410, engaging a hardware analyzer to analyze a piece of computer hardware. Engaging a hardware analyzer can include, for example, programming the analyzer to monitor a certain device, to monitor certain operations performed by the device, and so on. Engaging a hardware analyzer may also include, for example, programming a logic to store data produced by the hardware analyzer in a designated data store.

The method 400 may also include, at 420, engaging a software analyzer to analyze a piece of computer software that will service interrupts for the piece of computer hardware and/or poll the piece of computer hardware to ascertain a state, condition, register value, and so on. Engaging a software analyzer can include, for example, programming the software analyzer to monitor a certain piece of software (e.g., device driver that supports hardware that engaged hardware analyzer is monitoring), to monitor certain operations performed by the piece of software, and so on. Engaging a software analyzer can also include, for example, programming a logic to store data produced by the software analyzer in a designated data store.

The method 400 may also include, at 430, binding the hardware analyzer to the software analyzer to facilitate storing data received from the hardware analyzer and the software analyzer together, in order, based on time of occurrence. Binding the hardware analyzer to the software analyzer may include, for example, programming the hardware analyzer to analyze a piece of computer hardware identified by data available to the piece of software. Binding the hardware analyzer to the software analyzer may also include, for example, making a physical and/or logical connection in the correlating debugger. For example, the correlating debugger may include a memory configured to receive input from a software analyzer physically connected via a first port and a hardware analyzer physically connected via a second port.

The method 400 may also include, at 440, receiving an event that indicates that data storage should begin and, at 450, storing data received from the hardware analyzer and the software analyzer together, in order, based on time of occurrence. The event received may be, for example, an NMI, signal, or external trigger from the hardware analyzer indicating that the event the hardware analyzer was engaged to monitor has occurred. Storing the data together may include, in one example, retrieving data from a data store into which the hardware analyzer stored data, retrieving data from a data store into which the software analyzer stored data, resolving the times at which various data elements were produced, and storing the data elements in order based at the resolved times.

While FIG. 4 illustrates various actions occurring in serial, it is to be appreciated that various actions illustrated in FIG. 4 could occur substantially in parallel. By way of illustration, a first process could engage the hardware and software analyzers, a second process could bind the hardware and software analyzers, a third process could wait on an initiating event(s) and a fourth process could store data in a time-ordered data set. While four processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method that includes establishing a relationship in a debugger between a hardware device and a software component that will perform a software operation related to the hardware device by, identifying a hardware number known to the software component, communicating the hardware number to the hardware analyzer, correlating the software component and a hardware device based on the hardware number, and configuring the hardware analyzer to analyze the hardware device. The method may also include, configuring a software analyzer to collect a first data set as the software component performs the software operation and to deliver the first data set to the debugger. Configuring the software analyzer may include identifying types of data available in the software component to be reported on by the software analyzer, establishing a frequency with which the types of data will be sampled, and so on. The method may also include configuring a hardware analyzer to collect a second data set related to the hardware device as the hardware device performs a hardware operation and to deliver the second data set to the debugger. Configuring the hardware analyzer may include identifying types of data available in the hardware device to be reported on by the hardware analyzer, identifying types of events from the hardware device to be reported on by the hardware analyzer, and so on.

The method may also include detecting a first event that signals the beginning of the software operation and controlling the software analyzer to begin delivering the first data set to the debugger, where the software component may be a device driver and the first event may be a data packet arriving at a pre-determined, configurable level in the device driver. The method may also include detecting a second event that signals the beginning of the hardware operation and controlling the hardware analyzer to begin delivering the second data set to the debugger, where the second event may be a state change on an operable connection between the hardware device and the software component. The method may also include selectively storing the first data set and the second data set together, in order, where the order is based, at least in part, on the time at which an event associated with generating a member of the first data set or a member of the second data set occurred. While the above method is described being stored on a computer-readable medium, it is to be appreciated that other example methods described herein can also be stored on a computer-readable medium.

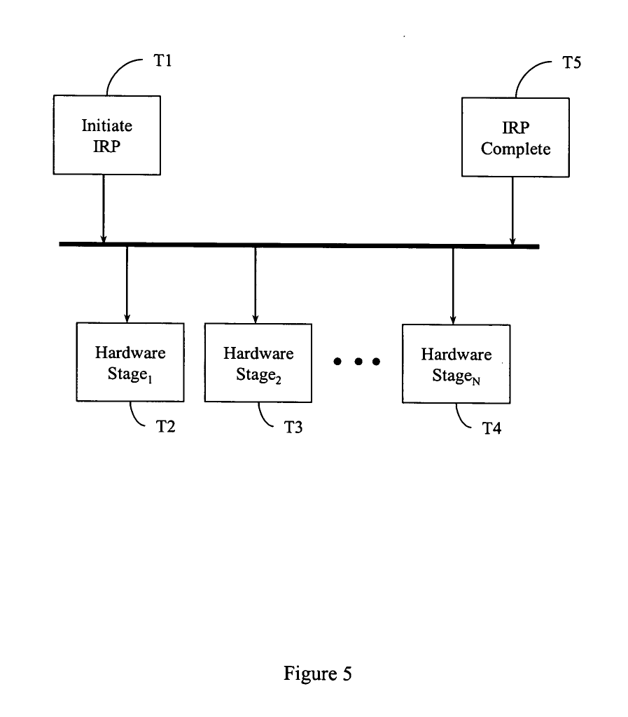

FIG. 5 illustrates an example timing diagram associated with a hardware and software interaction. The timing diagram reflects data organized from a session of analyzing a hardware device and software related to that hardware device. By way of illustration, a USB device may halt its operation (hang) after a process runs for a period of time on a Windows platform associated with the USB device. Thus, a hardware analyzer and a software analyzer may be employed, along with a correlating debugger, to produce an organized set of data (e.g., time ordered) that facilitates generating and/or viewing a timeline like that illustrated in FIG. 5.

A typical method that the Windows operating system employs to execute input/output (i/o) is through IRPs. IRPs are created and passed up and/or down through a device driver modular stack for initiation and completion. Once an IRP reaches a certain level in a device driver, (where the level may vary between various device drivers) the device driver may translate the software data into software packets of hardware signals. Software packets may follow the structure and handshake protocol established by the operating system. The software packets can thus be translated and initiated on a device and onto connections for i/o devices. The device signals follow a bus protocol. The hardware may then break the software packet down into smaller pieces that comply with bus transfer limits. Meanwhile, the device driver may be waiting for the hardware to report that the hardware has completed its operation and it is time to close the software transaction. Conventionally, hardware analyzers could analyze events associated with the hardware portion of a transaction and software debuggers could analyze the operation of the software but it was difficult, if even possible, to collect, organize, and/or correlate data from the analyzer and the debugger to study a hardware software interaction. Thus, a correlating debugger may facilitate producing an organized set of data collected from the hardware analyzer and the software analyzer and then correlated based on the mutual relationships of hardware device, operations, and time.

The organized data set may show at time T1 that a software transaction began. For example, at T1, an IRP may make its initial appearance in a device driver stack. At time T2, a signal from a hardware analyzer may indicate that a hardware transaction began on a physical bus. For example, a signal on a bus may transition from high (e.g., 5V) to low (e.g., 0V) indicating that a serial data packet is about to be transmitted. At time T3, another signal from the hardware analyzer may indicate that the serial data packet transmission began. Similarly, at time T4, another signal may show that the serial data packet transfer, and thus the hardware transaction completed. At T5, the software transaction may complete. For example, the IRP may exit the device drive stack. Typically, a software debugger would record the events associated with times T1 and T5 while a hardware analyzer would record the events associated with times T2, T3, and T4, and it would be difficult, if even possible, to correlate the data. Thus, a correlating debugger may facilitate producing a set of data that includes elements related to the events associated with T1 through T5, where the elements are correctly ordered to reflect the order in which they occurred.

Once an IRP is initiated and is about to be passed down in a device driver stack, a software debugger can be programmed to log the IRP address and the hardware device with which a device object related to the IRP is associated. Once the IRP reaches a certain device driver level, the device driver may start parsing it into smaller hardware packets that may be, for example, transmitted as instructions across a serial bus. The hardware analyzer may be programmed to output an external trigger to the software debugger upon the occurrence of an event. The debug unit that is running the software debugger may have installed an external trigger handler that logs the occurrence of the event and its associated time stamp. The resolution at which the hardware may output its marker trigger may be configured to facilitate employing a desired number of markers. Once a predetermined hardware stage is reached (e.g., hardware transaction completes), the IRP will flow back up and complete. Once completed, the software transaction is complete. While an IRP example is described, it is to be appreciated that the software analyzer, hardware analyzer, and correlating debugger may be employed with systems that do not employ IRPs.

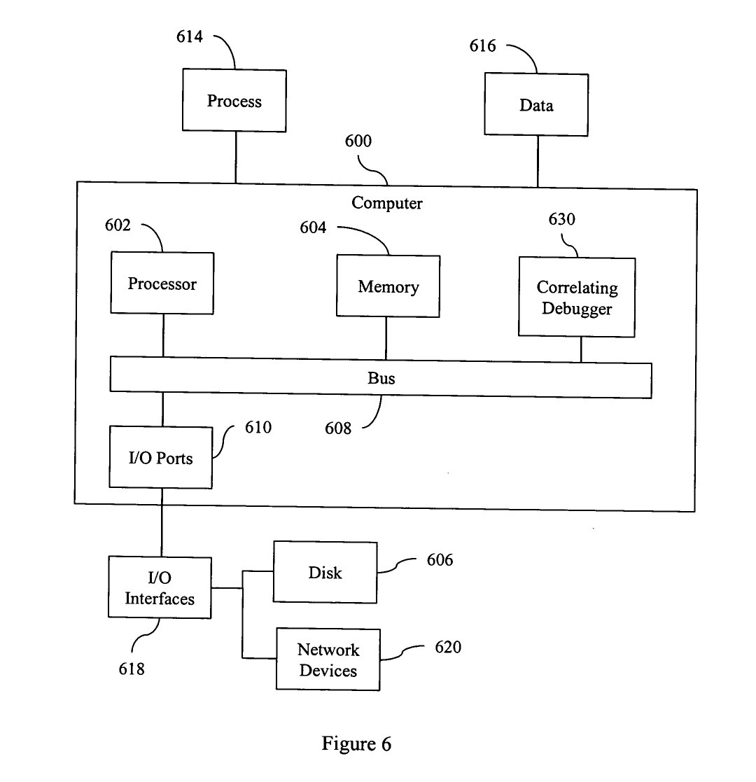

FIG. 6 illustrates an example computing environment in which example systems and methods illustrated herein can operate. Thus FIG. 6 illustrates a computer 600 that includes a processor 602, a memory 604, and input/output ports 610 operably connected by a bus 608. In one example, the computer 600 may include a correlating debugger 630 configured to facilitate analyzing a hardware/software interaction. For example, a network device 620 may be malfunctioning when the processor 602 runs a certain process 614. Thus, the correlating debugger 630 may be configured to monitor the process 614 in execution and, at the same time, receive data, information, interrupts and so on from a hardware analyzer (not illustrated) that analyzes the network device 620.

The processor 602 can be a variety of various processors including dual microprocessor and other multi-processor architectures. The memory 604 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. The disk 606 can include, but is not limited to, devices like a magnetic disk drive, a solid state disk drive, a floppy disk drive, a tape drive, a Zip drive, a flash memory card, and/or a memory stick. Furthermore, the disk 606 can include optical drives like a CD-ROM, a CD recordable drive (CD-R drive), a CD rewriteable drive (CD-RW drive), and/or a digital video ROM drive (DVD ROM). The memory 604 can store processes 614 and/or data 616, for example. The disk 606 and/or memory 604 can store an operating system that controls and allocates resources of the computer 600.

The bus 608 can be a single internal bus interconnect architecture and/or other bus or mesh architectures. While a single bus is illustrated, it is to be appreciated that computer 600 may communicate with various devices, logics, and peripherals using other busses that are not illustrated (e.g., PCIE, SATA, Infiniband, 1394, USB, Ethernet). The bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a PCI Express (PCIE) bus, a universal serial (USB) bus, and a small computer systems interface (SCSI) bus.

The computer 600 may interact with input/output devices via i/o interfaces 618 and input/output ports 610. Input/output devices can include, but are not limited to, a keyboard, a microphone, a pointing and selection device, cameras, video cards, displays, disk 606, network devices 620, and the like. The input/output ports 610 can include but are not limited to, serial ports, parallel ports, 1394 ports, and USB ports.

The computer 600 can operate in a network environment and thus may be connected to network devices 620 via the i/o devices 618, and/or the i/o ports 610. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network devices 620 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 620 can connect to WAN technologies including, but not limited to, point to point links, circuit switching networks like integrated services digital networks (ISDN), packet switching networks, and digital subscriber lines (DSL).

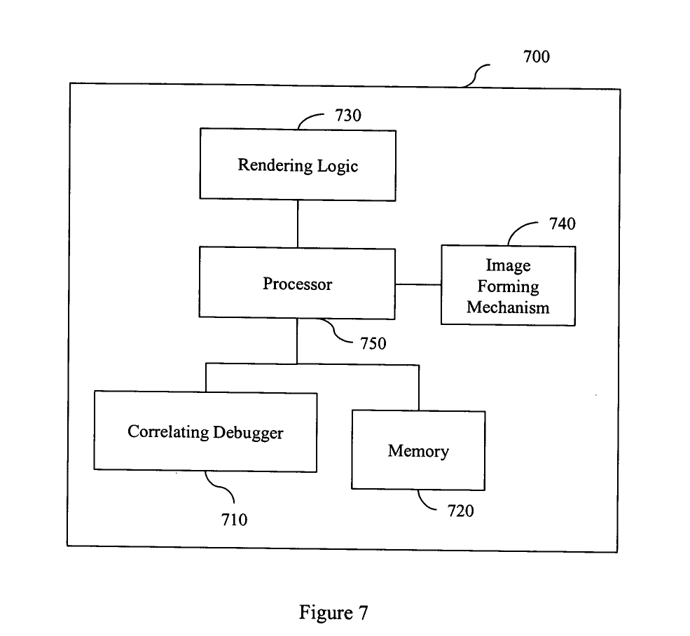

FIG. 7 illustrates an example image forming device 700 in which example systems and methods illustrated herein can operate. Thus FIG. 7 illustrates an example image forming device 700 that includes a correlating debugger 710 similar to the example systems described herein. The correlating debugger 710 may include logic configured to perform executable methods like those described herein. The correlating debugger 710 may be permanently and/or removably attached to the image forming device 700.

The image forming device 700 may receive print data to be rendered. Thus, image forming device 700 may also include a memory 720 configured to store print data or to be used more generally for image processing. The image forming device 700 may also include a rendering logic 730 configured to generate a printer-ready image from print data. Rendering varies based on the format of the data involved and the type of imaging device. In general, the rendering logic 730 converts high-level data into a graphical image for display or printing (e.g., the print-ready image). For example, one form is ray-tracing that takes a mathematical model of a three-dimensional object or scene and converts it into a bitmap image. Another example is the process of converting HTML into an image for display/printing. It is to be appreciated that the image forming device 700 may receive printer-ready data that does not need to be rendered and thus the rendering logic 730 may not appear in some image forming devices.

The image forming device 700 may also include an image forming mechanism 740 configured to generate an image onto print media from the print-ready image. The image forming mechanism 740 may vary based on the type of the imaging device 700 and may include a laser imaging mechanism, other toner-based imaging mechanisms, an ink jet mechanism, digital imaging mechanism, or other imaging reproduction engine. A processor 750 may be included that is implemented with logic to control the operation of the image-forming device 700. In one example, the processor 750 includes logic that is capable of executing Java instructions. Other components of the image forming device 700 are not described herein but may include media handling and storage mechanisms, sensors, controllers, and other components involved in the imaging process.

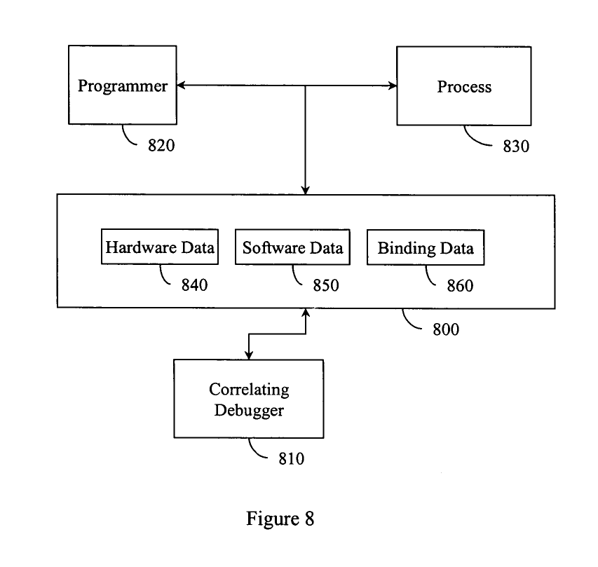

FIG. 8 illustrates an example application programming interface (API) 800. API 800 is illustrated facilitating access to a correlating debugger 810. A programmer(s) 820 and/or a process(es) 830 may use the API 800 to gain access to processing performed by the correlating debugger 810. For example, a programmer 820 can write a program to access the debugger 810 (e.g., invoke its operation, monitor its operation, control its operation) where writing the program is facilitated by the presence of the API 800. Rather than programmer 820 having to understand the internals of the debugger 810, the programmer 820 merely has to learn the interface to the debugger 810. This facilitates encapsulating the functionality of the debugger 810 while exposing that functionality.

Similarly, the API 800 can facilitate providing data values to the debugger 810 and/or retrieving data values from the debugger 810. For example, a process 830 that processes hardware data can provide this hardware data to the debugger 810 via the API 800 by, for example, using a call provided in the API 800. Thus, in one example of the API 800, a set of application programming interfaces can be stored on a computer-readable medium. The interfaces can be employed by a programmer 820, computer component, process 830, logic, and so on to gain access to a correlating debugger 810. The interfaces can include, but are not limited to, a first interface 840 that communicates data associated with a hardware analyzer and/or a hardware device being analyzed by the hardware analyzer, a second interface 850 that communicates data associated with a software analyzer and/or software that performs processing related to the hardware device being analyzed, and a third interface 860 that communicates binding data that facilitates relating the hardware analyzer and/or the hardware device with the software analyzer and/or software that performs processing related to the hardware device.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modem Legal Usage 624 (2d. Ed. 1995).

1. A correlating debugger, comprising:
a first logic configured to receive a first data set from a hardware analyzer that is configurable to analyze a hardware device;
a second logic configured to receive a second data set from a software analyzer that is configurable to analyze a software component;
a third logic configured to receive a binding data from the hardware analyzer or the software analyzer, where the binding data facilitates synchronizing the first data set and the second data set; and
a fourth logic operably connected to the first logic and the second logic, the fourth logic being configured to;
receive a signal that indicates that an interaction between the hardware device and the software component has occurred; and
upon receiving the signal, to selectively store elements of the first data set and the second data set in a time-ordered data set.

2. The correlating debugger of claim 1, where the first data set includes one or more of, timing information, state information, state change information, interrupt information, a register value, a memory location value, and voltage information.

3. The correlating debugger of claim 1, where the second data set includes one or more of, timing information, state information, state change information, interrupt information, a register value, a memory location value, a value for a data variable, information about a function call, information about a subroutine call, information about a method call, information about a stack, information about a heap, and information about a procedure call.

4. The correlating debugger of claim 1, where the hardware device comprises one of, a Universal Serial Bus (USB) device, a Small Computer Systems Interface (SCSI) device, an Industrial Standard Architecture (ISA) device, an Extended Industrial Standard Architecture (EISA) device, a Peripheral Component Interconnect (PCI) device, a PCI Express (PCIE) device, a Serial Advanced Technology Attachment (SATA) device, an Infiniband device, an Ethernet device, a 1394 device, and a Microchannel Architecture (MSA) device.

5. The correlating debugger of claim 1, where the software component comprises one of, a device driver, and an application.

6. The correlating debugger of claim 1, where the binding data comprises a hardware identifier.

7. The correlating debugger of claim 1, where the signal comprises a non-maskable interrupt.

8. The correlating debugger of claim 1, where the time-ordered data set includes one or more first elements of the first data set and one or more second elements of the second data set, where the first elements are arranged together with the second elements in order based on time.

9. The correlating debugger of claim 1, where the software component is configured to run on a first processor and a processor executable instructions associated with the first logic, the second logic, the third logic, or the fourth logic are configured to run on a second processor.

10. The correlating debugger of claim 1, where the software component and processor executable instructions associated with one or more of, the first logic, the second logic, the third logic, and the fourth logic are configured to run on a first processor.

11. The correlating debugger of claim 1, where the software analyzer comprises a kernel debugger.

12. A system, comprising:
a first logic configured to receive a first data set from a hardware analyzer that is configurable to analyze a USB hardware device, where the first data set includes one or more of, timing information, state information, state change information, interrupt information, a register value, a memory location value, and voltage information;
a second logic configured to receive a second data set from a software analyzer that is configurable to analyze a device driver, where the second data set includes one or more of, timing information, state information, state change information, interrupt information, a register value, a memory location value, a value for a data variable, information about a function call, information about a subroutine call, information about a method call, information about a stack, information about a heap, and information about a procedure call;
a third logic configured to receive a hardware identification number from the software analyzer or the software component, where the hardware identification number facilitates synchronizing the first data set with the second data set; and
a fourth logic operably connected to the first logic and the second logic, the fourth logic being configured;
to receive a non-maskable interrupt from the hardware analyzer that indicates that an interaction between the USB hardware device and the device driver has occurred; and
upon receiving the non-maskable interrupt, to selectively store the first data set and elements of the second data set together, in a time-ordered data set.

13. A correlating debugger, comprising:
means for receiving data from a hardware analyzer that is configured to analyze a piece of computer hardware;
means for receiving data from a software analyzer that is configured to analyze a device driver configured to perform one or more of, processing interrupts from the piece of computer hardware, polling the piece of computer hardware, and polling a bus by which the piece of computer hardware and the software analyzer are operably connected;
means for coordinating the analysis of the hardware analyzer and the software analyzer so that data received from the hardware analyzer and data received from the software debugger can be merged in a time-ordered set of data; and
means for initiating writing data received from the hardware analyzer and data received from the software analyzer to the time-ordered set of data.

14. A method, comprising:
establishing a relationship in a debugger between a hardware device and a software component that will perform a software operation related to the hardware device;
configuring a software analyzer to collect a first data set related to the software component as the software component performs the software operation and to cause the first data set to be delivered to the debugger;
configuring a hardware analyzer to collect a second data set related to the hardware device as the hardware device performs a hardware operation and to cause the second data set to be delivered to the debugger;
detecting a first event that signals a beginning of the software operation and controlling the software analyzer to begin delivering the first data set to the debugger;
detecting a second event that signals a beginning of the hardware operation and controlling the hardware analyzer to begin delivering the second data set to the debugger; and
selectively storing together, in order, elements of the first data set and elements of the second data set, where the order is based, at least in part, on the time at which an event associated with generating an element occurred.

15. The method of claim 14, where establishing the relationship includes:
identifying a hardware number known to the software component;
communicating the hardware number to the hardware analyzer;
correlating the software component and a hardware device based on the hardware number; and
configuring the hardware analyzer to analyze the hardware device.

16. The method of claim 15, where the hardware number is based on an I/O request packet (IRP).

17. The method of claim 14, where configuring the software analyzer includes one or more of:
identifying one or more types of data available in the software component to be reported on by the software analyzer; and
establishing a frequency with which the one or more types of data will be sampled.

18. The method of claim 14, where configuring the hardware analyzer includes or more of, identifying one or more types of data available in the hardware device to be reported on by the hardware analyzer, and identifying one or more types of events from the hardware device to be reported on by the hardware analyzer.

19. The method of claim 14, where the software component comprises a device driver and the first event comprises an I/O request packet (IRP) arriving at a pre-determined, configurable level in the device driver.

20. The method of claim 14, where the second event comprises a state change on an operable connection between the hardware device and the software component.

21. The method of claim 14, where selectively storing together elements of the first data set and elements of the second data set includes selectively adding an element of the second data set to the first data set.

22. A computer-readable medium storing processor executable instructions operable to perform a method, the method comprising:
establishing a relationship in a debugger between a hardware device and a software component that will perform a software operation related to the hardware device by:
identifying a hardware number known to the software component;
communicating the hardware number to the hardware analyzer;
correlating the software component and a hardware device based on the hardware number; and
configuring the hardware analyzer to analyze the hardware device;
configuring a software analyzer to collect a first data set as the software component performs the software operation and to deliver the first data set to the debugger, where configuring the software analyzer includes one or more of, identifying one or more types of data available in the software component to be reported on by the software analyzer, and establishing a frequency with which the one or more types of data will be sampled;
configuring a hardware analyzer to collect a second data set related to the hardware device as the hardware device performs a hardware operation and to deliver the second data set to the debugger, where configuring the hardware analyzer includes or more of, identifying one or more types of data available in the hardware device to be reported on by the hardware analyzer, and identifying one or more types of events from the hardware device to be reported on by the hardware analyzer;
detecting a first event that signals the beginning of the software operation and controlling the software analyzer to begin delivering the first data set to the debugger, where the software component comprises a device driver and the first event comprises an I/O request packet arriving at a pre-determined, configurable level in the device driver;
detecting a second event that signals the beginning of the hardware operation and controlling the hardware analyzer to begin delivering the second data set to the debugger, where the second event comprises a state change on an operable connection between the hardware device and the software component; and
selectively storing the first data set and the second data set together, in order, where the order is based, at least in part, on the time at which an event associated with generating a member of the first data set or a member of the second data set occurred.

23. A method, comprising:
engaging a hardware analyzer to analyze a piece of computer hardware;
engaging a software analyzer to analyze a piece of computer software that will service interrupts for the piece of computer hardware;
binding the hardware analyzer to the software analyzer to facilitate storing data received from the hardware analyzer and the software analyzer together, in order, based on time of occurrence;
receiving an event that indicates that data storage should begin; and
storing data received from the hardware analyzer and the software analyzer together, in order, based on time of occurrence.

24. The method of claim 23, where binding the hardware analyzer to the software analyzer includes programming the hardware analyzer to analyze a piece of computer hardware identified by a hardware number in an I/O request packet (IRP) available to the piece of software.

25. The method of claim 23, where binding the hardware analyzer to the software analyzer includes establishing a logic connection in a correlating debugger configured to receive data from the hardware analyzer and the software analyzer.

26. The method of claim 23, where binding the hardware analyzer to the software analyzer includes establishing a physical connection at a correlating debugger configured to receive data from the hardware analyzer and the software analyzer.

27. In a computer system having a graphical user interface comprising a display and a selection device, a method of providing and selecting from a set of data entries on the display, the method comprising:
retrieving a set of data entries, where a data entry represents an operation associated with ordering data received from a hardware analyzer configured to analyze a hardware device and a software debugger configured to analyze a device driver configured to perform one or more of, servicing interrupts from the hardware device, polling the hardware device and polling a bus by which the piece of computer hardware and the software debugger are operably connected;
displaying the set of data entries on the display;
receiving a data entry selection signal indicative of the selection device selecting a selected data entry; and
in response to the data entry selection signal, initiating an operation associated with the selected data entry.

28. A computer-readable medium having stored thereon a data structure comprising:
a first field containing data received from a hardware analyzer configured to analyze a hardware device;
a second field containing data received from a software debugger configured to analyze a software component that will perform one or more of, servicing interrupts related to the hardware device and polling the hardware device; and
a third field containing data derived from the first field and the second field, where the data in the third field is arranged in order, based on time.

29. A set of application programming interfaces embodied on a computer-readable medium for execution by a computer component in conjunction with ordering debug information, comprising:
a first interface for communicating data associated with a hardware analyzer or a hardware device being analyzed by the hardware analyzer;
a second interface for communicating data associated with a software debugger or a software component being analyzed by the software debugger; and
a third interface for communicating data that facilitates binding the software debugger or the software component with the hardware analyzer or the hardware device to facilitate ordering debug information produced by the hardware analyzer and the software analyzer.

30. A system for correlating debug data, comprising:
a first logic configured to receive a hardware related debug data from a hardware analyzer;
a second logic configured to receive a software related debug data from a software analyzer;
means for establishing a relationship between the hardware analyzer and the software analyzer to facilitate correlating data received by the first logic and data received by the second logic into a time-ordered set of data.
